(19) United States
(12) Patent Application Publication
(10) Pub. No.: US 2017/0270110 A1
(43) Pub. Date: Sep. 21, 2017

(54) SYSTEM AND METHOD FOR DETECTING ABNORMALITY IDENTIFIERS BASED ON SIGNATURES GENERATED FOR MULTIMEDIA CONTENT ELEMENTS

(71) Applicant: Cortica, Ltd., TEL AVIV (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/614,982

(22) Filed: Jun. 6, 2017

Related U.S. Application Data
(63) Continuation-in-part of application No. 14/050,991, filed on Oct. 10, 2013.
Application No. 14/050,991 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009.
(60) Provisional application No. 62/347,126, filed on Jun. 8, 2016.
(60) Provisional application No. 62/347,643, filed on Jun. 9, 2016.
(60) Provisional application No. 61/860,261, filed on Jul. 31, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/3002; Y10S 707/99943; G06F 17/30109; G06F 17/301; Y10S 707/99948

(57) ABSTRACT

A method for detecting abnormality identifiers based on multimedia content element signatures. The method includes causing generation of at least one signature for at least one input multimedia content element, wherein each signature represents a concept, wherein each concept is a collection of signatures and metadata representing the concept; comparing the generated at least one signature to a plurality of signatures of a plurality of reference multimedia content elements to determine at least one matching reference multimedia content element; and detecting, based on the comparison, at least one abnormality identifier for the at least one input multimedia content element.

### CROSS-REFERENCE TO RELATED APPLICATIONS

This application claims the benefit of U.S. Provisional Application No. 62/347,126 filed on Jun. 8, 2016, and of U.S. Provisional Application No. 62/347,643 filed on Jun. 9, 2016. This application is also a continuation-in-part (CIP) of U.S. patent application Ser. No. 14/050,991 filed on Oct. 10, 2013, now pending, which claims the benefit of U.S. Provisional Application No. 61/860,261 filed on Jul. 31, 2013. The Ser. No. 14/050,991 application is also a CIP of U.S. patent application Ser. No. 13/602,858 filed Sep. 4, 2012, now U.S. Pat. No. 8,868,619, which is a continuation of U.S. patent application Ser. No. 12/603,123, filed on Oct. 21, 2009, now U.S. Pat. No. 8,266,185. The Ser. No. 12/603,123 application is a CIP of:

(1) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006;

(2) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a CIP of the above-referenced U.S. patent application Ser. No. 12/084,150;

(3) U.S. patent application Ser. No. 12/348,888 filed on Jan. 5, 2009, now pending, which is a CIP of the above-referenced U.S. patent application Ser. Nos. 12/084,150 and 12/195,863; and

(4) U.S. patent application Ser. No. 12/538,495 filed on Aug. 10, 2009, now U.S. Pat. No. 8,312,031, which is a CIP of the above-referenced U.S. patent application Ser. Nos. 12/084,150; 12/195,863; and 12/348,888.

All of the applications referenced above are herein incorporated by reference for all that they contain.

### TECHNICAL FIELD

The present disclosure relates generally to the analysis of multimedia content, and more specifically to analyzing multimedia content elements to detect identifiers of diseases.

### BACKGROUND

Computed Tomography (CT) is an imaging technique that utilizes a medical imaging apparatus having a high signal-to-noise ratio and a high resolution that allows for clearly observing small objects. CT systems may further provide cross-sectional images, thereby allowing for showing of an internal structure of an object (e.g., organs such as a kidney, a liver, a lung, etc.) of the object without overlapping of other images. CT systems may be utilized to capture images showing symptoms of diseases such as, for example, brain disease, lung cancer, esophageal cancer, liver cancer, gastrointestinal tumors, and bone tumors.

Magnetic Resonance Imaging (MRI) is an imaging technique that utilizes a powerful magnetic field, radio waves, and a computer to produce detailed images of the inside of a patient's body. MRI may be utilized to diagnose or monitor a variety of conditions related to, e.g., the chest, abdomen, and pelvis; as well as to monitor development of babies in pregnant women.

As compared to CT or MRI systems, an ultrasound (US) apparatus has a low signal-to-noise ratio and a relatively unclear image quality. As a result, an US apparatus cannot be effectively utilized to monitor diseases such as cancer, but provides images in real-time with minimal side effects. Thus, US apparatuses have been widely adopted in medical fields requiring information related to, e.g., lesion diagnosis, biopsy, and radio-frequency ablation.

Some existing solutions for detecting the presence of identifiers of the above-noted diseases include manual observation of images produced by medical imaging systems by a medical professional who is specifically trained to diagnose specific medical conditions. However, such medical professionals may not be readily accessible due to, e.g., high number of patients, vacations, incompatible office hours, and the like. Patients seeking self-diagnosis via, e.g., the Internet, often receive inaccurate or inappropriate information, thereby resulting in misdiagnosis by the patient.

Some existing solutions may also include automated analysis of medical images. However, such existing automated solutions often face challenges in accurately detecting indicators of diseases, particularly when comparing patients with unusual physiology as compared to sample images.

It would be therefore advantageous to provide a solution that overcomes the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for based on multimedia content element signatures. The method comprises: causing generation of at least one signature for at least one input multimedia content element, wherein each signature represents a concept, wherein each concept is a collection of signatures and metadata representing the concept; comparing the generated at least one signature to a plurality of signatures of a plurality of reference multimedia content elements to determine at least one matching reference multimedia content element; and detecting, based on the comparison, at least one abnormality identifier for the at least one input multimedia content element.

Certain embodiments disclosed herein also include a non-transitory computer readable medium having stored thereon causing a processing circuitry to execute a process, the process comprising: causing generation of at least one signature for at least one input multimedia content element, wherein each signature represents a concept, wherein each concept is a collection of signatures and metadata representing the concept; comparing the generated at least one signature to a plurality of signatures of a plurality of reference multimedia content elements to determine at least one matching reference multimedia content element; and detecting, based on the comparison, at least one abnormality identifier for the at least one input multimedia content element.

Certain embodiments disclosed herein also include a system for based on multimedia content element signatures. The system comprises: a processing circuitry; and a memory, the memory containing instructions that, when executed by the processing circuitry, configure the system to: cause generation of at least one signature for at least one input multimedia content element, wherein each signature represents a concept, wherein each concept is a collection of signatures and metadata representing the concept; compare the generated at least one signature to a plurality of signatures of a plurality of reference multimedia content elements to determine at least one matching reference multimedia content element; and detect, based on the comparison, at least one abnormality identifier for the at least one input multimedia content element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various embodiments disclosed herein.

FIG. 2 is a flowchart illustrating a method for detecting abnormality identifiers based on multimedia content element signatures according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a schematic diagram of a detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some disclosed features but not to others. In general, unless otherwise indicated, singular elements may be in plural and vice versa with no loss of generality. In the drawings, like numerals refer to like parts through several views.

The various disclosed embodiments include a system and a method for detecting abnormality identifiers based on multimedia content element signatures. At least one input multimedia content element is received. The input multimedia content elements may include images generated by a medical imaging system such as, but not limited to, computerized tomography images, magnetic resonance imaging images, ultrasound images, and the like. Based on signatures generated for the at least one input multimedia content element, at least one abnormality identifier is detected. Each signature represents a concept, where each concept is a collection of signatures and metadata representing the concept. Each signature may be robust to noise and distortion. Each signature may be generated by a signature generator system, the signature generator system including a plurality of at least partially statistically independent computational cores, where the properties of each core are set independently of the properties of each other core.

In an embodiment, detecting the abnormality identifiers includes generating at least one signature for each of the at least one input multimedia content element and matching the generated signatures to a plurality of signatures of reference multimedia content elements associated with predetermined abnormality identifiers. Each abnormality identifier associated with a reference multimedia content element matching an input multimedia content element as determined based on the signature matching may be assigned to the input multimedia content element.

In another embodiment, detecting the abnormality identifiers includes sending the at least one input multimedia content element, the at least one signature generated for the at least one input multimedia content element, or both, to a deep content classification system and receiving, from the deep content classification system, at least one matching concept. The detected abnormality identifiers may be created based on metadata of each matching concept.

In an embodiment, at least one data source may be queried based on the detected abnormality identifiers. In a further embodiment, search results indicating potential diseases may be received from the queried at least one data source. The search results may be sent to, e.g., a user device, for storage, for display, or both.

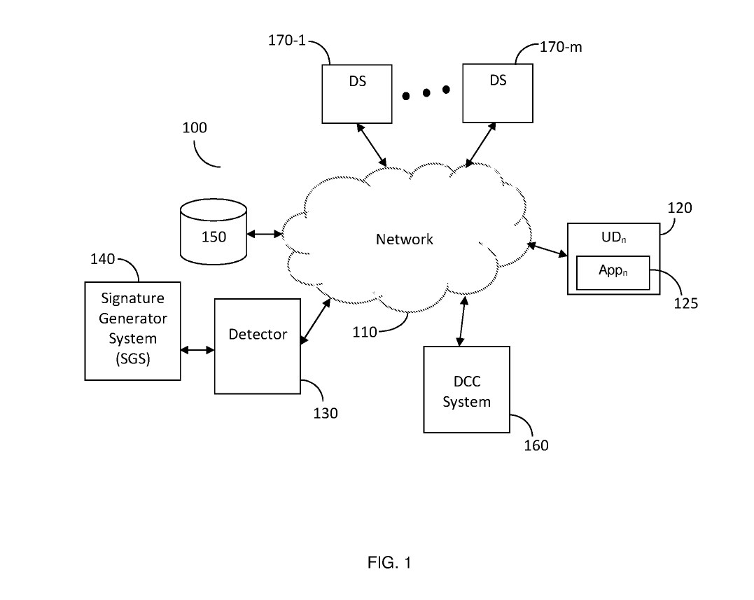

FIG. 1 shows an example network diagram 100 utilized to describe the various disclosed embodiments. The network diagram includes a user device 120, a detector 130, a database 150, a deep content classification (DCC) system 160, and a plurality of data sources 170-1 through 170-m (hereinafter referred to individually as a data source 170 and collectively as data sources 170, merely for simplicity purposes). The network 110 may be the Internet, the world-wide-web (WWW), a local area network (LAN), a wide area network (WAN), a metro area network (MAN), and other networks capable of enabling communication between the elements of the network diagram 100.

The user device 120 may be, but is not limited to, a personal computer (PC), a personal digital assistant (PDA), a mobile phone, a smart phone, a tablet computer, an electronic wearable device (e.g., glasses, a watch, etc.), and other kinds of wired and mobile appliances, equipped with browsing, viewing, capturing, storing, listening, filtering, and managing capabilities enabled as further discussed herein below. The user device 120 may include a display for displaying abnormality identifiers, search results obtained using abnormality identifiers, and the like.

The user device 120 may further include an application (App) 125 installed thereon. The application 125 may be downloaded from an application repository, such as the AppStore®, Google Play®, or any repositories hosting software applications. The application 125 may be pre-installed in the user device 120. In an embodiment, the application 125 may be a web-browser. The application 125 may be configured to receive, from the detector 130, abnormality identifiers, search results, or both, via an interface (not shown) of the user device 120 and to cause a display of the received data via a display (not shown) of the user device 120. It should be noted that only one user device 120 and one application 125 are discussed with reference to FIG. 1 merely for the sake of simplicity. However, the embodiments disclosed herein are applicable to a plurality of user devices each having an application installed thereon.

The database 150 stores at least reference multimedia content elements and abnormality identifiers associated with the reference multimedia content elements. In the example network diagram 100, the detector 130 is communicatively connected to the database 150 through the network 110. In other non-limiting configurations, the detector 130 may be directly connected to the database 150.

Each of the data sources 170 is a searchable data source including content related to one or more diseases. To this end, the data sources 170 may include, but are not limited to, servers or data repositories of entities such as, for example, medical professional organizations, medical practice groups, hospitals, governmental organizations, and the like.

The signature generator system (SGS) 140 and the deep-content classification (DCC) system 160 may be utilized by the detector 130 to perform the various disclosed embodiments. Each of the SGS 140 and the DCC system 160 may be connected to the detector 130 directly or through the network 110. In certain configurations, the DCC system 160 and the SGS 140 may be embedded in the detector 130.

In an embodiment, the detector 130 is configured to receive or retrieve input multimedia content elements for which abnormality identifiers are to be identified. In a further embodiment, the detector 130 is configured to cause generation of signatures for the input multimedia content elements. Based on the generated signatures, the detector 130 is configured to determine at least one abnormality identifier of the input multimedia content elements.

The abnormality identifiers may include previously created abnormality identifiers. Alternatively or collectively, the detector 130 may be configured to create abnormality identifiers for at least one of the input multimedia content elements. In an example implementation, the detector 130 may be configured to create abnormality identifiers only for input multimedia content elements that do not match any reference multimedia content elements associated with predetermined abnormality identifiers.

In an embodiment, the detector 130 is configured to send the input multimedia content elements to the signature generator system 140, to the deep content classification system 160, or both. In a further embodiment, the detector 130 is configured to receive a plurality of signatures generated to the multimedia content element from the signature generator system 140, to receive a plurality of signatures (e.g., signature reduced clusters) of concepts matched to the multimedia content element from the deep content classification system 160, or both. In another embodiment, the detector 130 may be configured to generate the plurality of signatures, identify the plurality of signatures (e.g., by determining concepts associated with the signature reduced clusters matching each input multimedia content element), or a combination thereof.

In an embodiment, detecting the abnormality identifiers for a multimedia content element includes causing generation of at least one signature for the input multimedia content element and comparing the generated at least one signature to a plurality of signatures generated for reference multimedia content elements stored in, e.g., the database 150. Each reference multimedia content element is associated with at least one predetermined abnormality identifier or at least one baseline identifier.

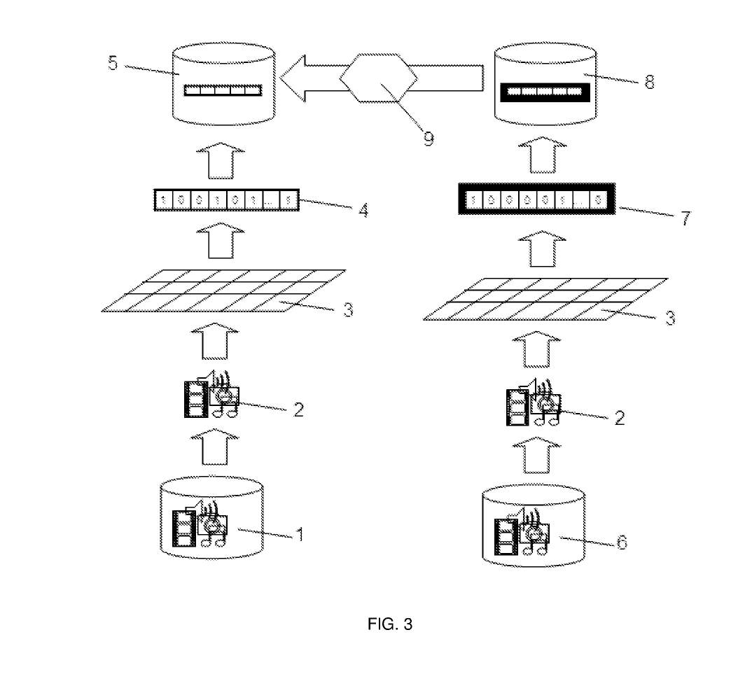

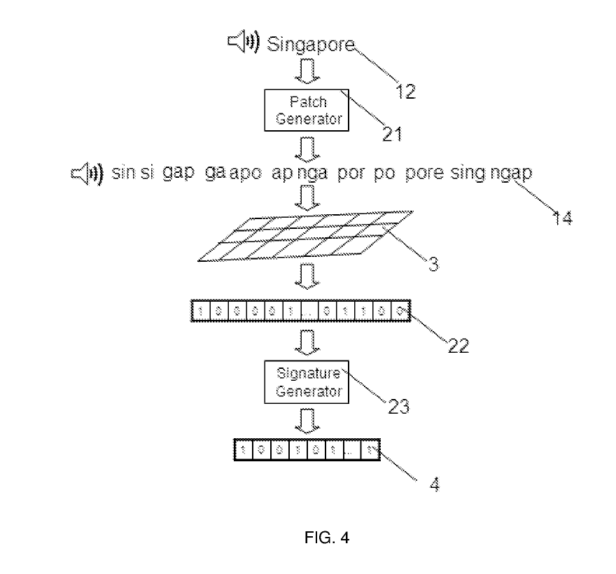

In an embodiment, the detected abnormality identifiers may include predetermined abnormality identifiers associated with each reference multimedia content element matching at least one of the input multimedia content elements. An input multimedia content element and a reference multimedia content element may be matching if signatures generated for the input multimedia content element match signatures of the reference multimedia content element above a predetermined threshold. The process of matching between signatures of multimedia content elements is discussed in detail herein below with respect to FIGS. 3 and 4.

In another embodiment, the abnormality identifiers of the input multimedia content elements may be detected with respect to differences between portions of the input multimedia content element signatures and portions of the reference multimedia content element signatures representing baseline identifiers. Each baseline identifier is an identifier illustrating a known normal or otherwise expected condition that may be featured in, e.g., images captured by medical imaging systems. As a non-limiting example, for images of a skull captured by an MRI machine, a baseline identifier may include a normal shape or unfractured condition of the skull such that deviations from the baseline identifier indicate abnormal shape or fractured skull, respectively, which are likely to indicate an injury to or other deformity of the skull.

Each signature represents a concept structure (hereinafter referred to as a “concept”). A concept is a collection of signatures representing elements of the unstructured data and metadata describing the concept. As a non-limiting example, a ‘Superman concept’ is a signature-reduced cluster of signatures describing elements (such as multimedia elements) related to, e.g., a Superman cartoon: a set of metadata representing proving textual representation of the Superman concept. Techniques for generating concept structures are also described in the above-referenced U.S. Pat. No. 8,266,185.

In another embodiment, the detector 130 is configured to create the abnormality identifiers by sending the input multimedia content elements to the DCC system 160 to match each input multimedia content element to at least one concept structure. If such a match is found, then the metadata of the concept structure may be used to generate abnormality identifiers to be assigned the input multimedia content element. The identification of a concept matching the received multimedia content element includes matching at least one signature generated for the received element (such signature(s) may be produced either by the SGS 140 or the DCC system 160) and comparing the element's signatures to signatures representing a concept structure. The matching can be performed across all concept structures maintained by the system DCC 160.

It should be noted that, if the DCC system 160 returns multiple concept structures, a correlation for matching concept structures may be performed to generate abnormality identifiers that best describes the element. The correlation can be achieved by identifying a ratio between signatures' sizes, a spatial location of each signature, and using the probabilistic models.

It should further be noted that using signatures generated for multimedia content elements enables accurate identification of abnormality identifiers, because the signatures generated for the multimedia content elements, according to the disclosed embodiments, allow for recognition and classification of multimedia content.

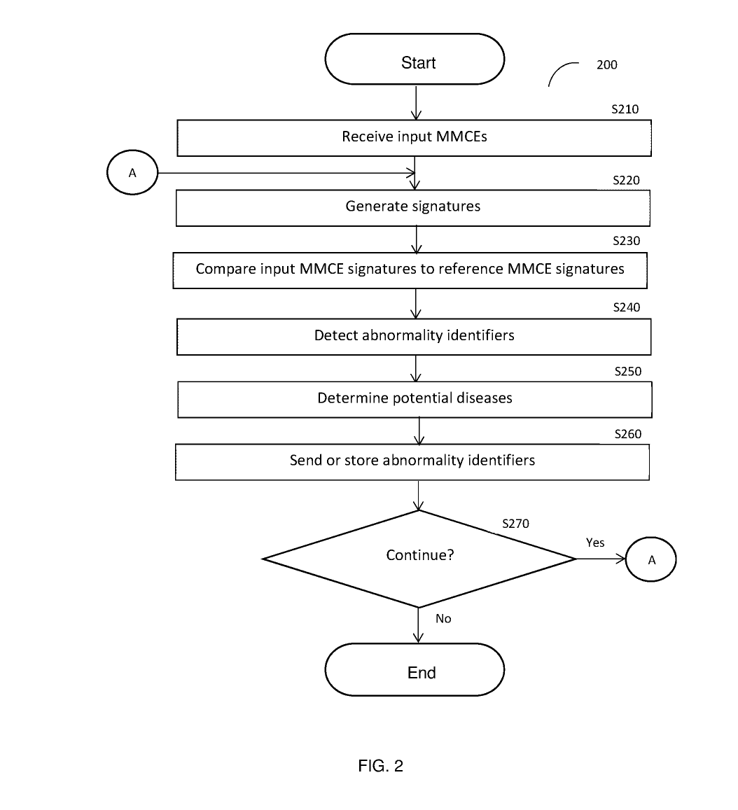

FIG. 2 depicts an example flowchart 200 describing a method for detecting abnormality identifiers based on multimedia content element signatures according to an embodiment.

At S210, at least one input multimedia content element (MMCE) is received. Alternatively or collectively, the at least one input multimedia content element may be retrieved from, e.g., a user device, one or more data sources, both, and the like. In an embodiment, S210 may further include receiving or retrieving metadata associated with the input multimedia content elements.

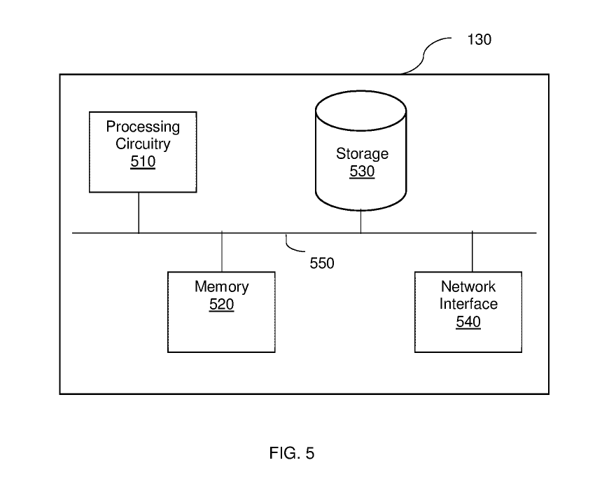

At S220, at least one signature is generated for one of the input multimedia content elements. The signature(s) are generated by a signature generator system (e.g., the SGS 140) as described below with respect to FIGS. 4 and 5.

At S230, the generated at least one signature is compared to a plurality of signatures of reference multimedia content elements. The reference multimedia content elements may include abnormality identifier reference multimedia content elements showing sample abnormality identifiers, baseline reference multimedia content elements showing baseline identifiers, or both. In an embodiment, S230 includes comparing portions of the at least one generated signature to corresponding portions of the reference multimedia content elements to determine if such corresponding portions match above a predetermined threshold.

At S240, based on the comparison, at least one abnormality identifier of the input multimedia content element is detected. In an embodiment, the detected at least one abnormality identifier may include abnormality identifiers represented by matching portions of the reference multimedia content elements when the reference multimedia content elements are associated with predetermined abnormality identifiers. In another embodiment, the at least one abnormality identifier may be detected based on differences between portions of the generated at least one signature and corresponding portions of the reference multimedia content element signatures when the reference multimedia content elements feature baseline identifiers.

The abnormality identifiers may include visual identifiers such as, but not limited to, tumors, kidney stones, bladder stones, skeletal injuries (e.g., fractures), internal organa abnormalities (e.g., color, shape, size, etc.), presence or absence of fluid, and the like.

The detected abnormality identifiers may include signatures matching the abnormality identifier reference multimedia content elements or signatures not matching the baseline reference multimedia content elements. Alternatively, the detected abnormality identifiers may include textual representations of such signatures. To this end, S230 may further include comparing the matching or non-matching signatures to signatures associated with predetermined textual representations of abnormality identifiers.

At optional S250, based on the detected abnormality identifiers, at least one potential disease may be determined. In an embodiment, S250 may include searching through at least one data source for potential diseases based on the detected abnormality identifiers. The searching may utilize the signatures representing the detected abnormality identifiers, textual representations of the detected abnormality identifiers, or both. In an embodiment, the search may be performed, for example, using the input multimedia content element as a search query as further described in co-pending U.S. patent application Ser. No. 13/773,112 assigned to the common assignee, the contents of which are hereby incorporated by reference.

At optional S260, the detected abnormality identifiers, the search results, or both, may be sent to a user device, to a database for storage, or both.

At S270, it is checked whether abnormality identifiers for additional input multimedia content elements are to be detected and, if so, execution continues with S220, where abnormality identifiers a new input multimedia content element are detected; otherwise, execution terminates.

As a non-limiting example, an input image showing a MRI scan of a person's chest is received. Signatures are generated for the input image. The signatures are compared to signatures of reference multimedia content elements featuring baseline identifiers for normal MRI scans. Based on the comparison, it is determined that a part of the input image represented by a first signature (or portion thereof) showing the walls of the chest is different from a corresponding second signature of a baseline identifier image. The first signature is identified as representing the abnormality identifier. The first signature or a textual representation of the concept represented by the first signature may be utilized to search for potential diseases, thereby resulting in potential diseases such as a chest wall tumor, chest wall phlegmons, and abscesses. The potential disease search results may be provided to a user device for display.

FIGS. 3 and 4 illustrate the generation of signatures for the multimedia content elements by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment, the SGS 140 is configured with a plurality of computational cores to perform matching between signatures.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the detector 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Thₛ) and Robust Signature (Th_{RS}) are set apart, after optimization, according to at least one or more of the following criteria:

### For:

Vᵢ>Th_{RS}

1−p(V>Th_{S})−1−(1−ε)^{l}<<1 1

i.e., given that l nodes (cores) constitute a Robust Signature of a certain image I, the probability that not all of these I nodes will belong to the Signature of same, but noisy image, Ĩ is sufficiently low (according to a system's specified accuracy).

p(Vᵢ>Th_{RS})˜l/L 2

i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the above-referenced U.S. Pat. No. 8,655,801.

FIG. 5 is an example schematic diagram of the detector 130 according to an embodiment. The detector 130 includes a processing circuitry 510 coupled to a memory 520, a storage 530, and a network interface 540. In an embodiment, the components of the detector 130 may be communicatively connected via a bus 650.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 510 may be realized as an array of at least partially statistically independent computational cores. The properties of each computational core are set independently of those of each other core, as described further herein above.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein. Specifically, the instructions, when executed, cause the processing circuitry 510 to provide recommendations of trending content based on context as described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the detector 130 to communicate with the signature generator system 140 for the purpose of, for example, sending multimedia content elements, receiving signatures, and the like. Further, the network interface 540 allows the detector 130 to receive queries, send search results, store tags and associated multimedia content elements or signatures, and the like.

It should be understood that the embodiments described herein are not limited to the specific architecture illustrated in FIG. 5, and other architectures may be equally used without departing from the scope of the disclosed embodiments. In particular, the detector 130 may further include a signature generator system configured to generate signatures, a tag generator configured to generate tags for multimedia content elements based on signatures, or both, as described herein, without departing from the scope of the disclosed embodiments.

It should be further noted that various embodiments described herein are discussed with respect to determining potential diseases merely for simplicity purposes and without limitation on the disclosed embodiments. The disclosed embodiments are equally applicable to other abnormalities that may or may not be classified as diseases without departing from the scope of the disclosure. For example, identifiers of high arched feet may be detected, where such identifiers may represent a disease or may represent an inherited condition that may not otherwise be classified as a disease.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for detecting abnormality identifiers based on multimedia content element signatures, comprising:
causing generation of at least one signature for at least one input multimedia content element, wherein each signature represents a concept, wherein each concept is a collection of signatures and metadata representing the concept;
comparing the generated at least one signature to a plurality of signatures of a plurality of reference multimedia content elements to determine at least one matching reference multimedia content element; and
detecting, based on the comparison, at least one abnormality identifier for the at least one input multimedia content element.

2. The method of claim 1, wherein the signatures of each matching reference multimedia content element match the at least one signature generated for the at least one input multimedia content element above a predetermined threshold.

3. The method of claim 1, wherein detecting the at least one abnormality identifier further comprises:
sending, to a deep content classification system, at least one of: the at least one input multimedia content element, and the at least one signature generated for the at least one input multimedia content element;
receiving, from the deep concept classification system, at least one concept matching the at least one input multimedia content element; and
creating at least one abnormality identifier for the input multimedia content element, wherein each created abnormality identifier includes at least a portion of the metadata representing the matching at least one concept.

4. The method of claim 1, wherein each reference multimedia content element is associated with at least one predetermined abnormality identifier, wherein the detected at least one abnormality identifier includes the at least one predetermined abnormality identifier of each matching reference multimedia content element.

5. The method of claim 1, wherein the at least one reference multimedia content element includes at least one normal reference multimedia content element featuring at least one baseline identifier, wherein each abnormality identifier is detected with respect to a difference between one of the at least one baseline identifier and the at least one input multimedia content element.

6. The method of claim 1, further comprising:
searching, using the detected at least one abnormality identifier, for at least one potential disease.

7. The method of claim 6, wherein the at least one potential disease includes a plurality of potential diseases, further comprising:
sending, to a user device, a list of the plurality of potential diseases, wherein the list is organized based on at least one of: a degree of commonness of each potential disease, and a degree of matching between corresponding portions of each input multimedia content element and each reference multimedia content element.

8. The method of claim 1, wherein each input multimedia content element is at least one of: an image, graphics, a video stream, a video clip, an audio stream, an audio clip, a video frame, a photograph, images of signals, and a portion thereof.

9. The method of claim 1, wherein each signature is generated by a signature generator system, wherein the signature generator system includes a plurality of at least partially statistically independent computational cores, wherein the properties of each core are set independently of the properties of each other core.

10. A non-transitory computer readable medium having stored thereon instructions for causing a processing circuitry to execute a process, the process comprising:
causing generation of at least one signature for at least one input multimedia content element, wherein each signature represents a concept, wherein each concept is a collection of signatures and metadata representing the concept;
comparing the generated at least one signature to a plurality of signatures of a plurality of reference multimedia content elements to determine at least one matching reference multimedia content element; and
detecting, based on the comparison, at least one abnormality identifier for the at least one input multimedia content element.

11. A system for detecting abnormality identifiers based on multimedia content element signatures, comprising:
a processing circuitry; and
a memory connected to the processing circuitry, the memory containing instructions that, when executed by the processing circuitry, configure the system to:
cause generation of at least one signature for at least one input multimedia content element, wherein each signature represents a concept, wherein each concept is a collection of signatures and metadata representing the concept;
compare the generated at least one signature to a plurality of signatures of a plurality of reference multimedia content elements to determine at least one matching reference multimedia content element; and
detect, based on the comparison, at least one abnormality identifier for the at least one input multimedia content element.

12. The system of claim 11, wherein the signatures of each matching reference multimedia content element match the at least one signature generated for the at least one input multimedia content element above a predetermined threshold.

13. The system of claim 11, wherein the system is further configured to:
send, to a deep content classification system, at least one of: the at least one input multimedia content element, and the at least one signature generated for the at least one input multimedia content element;
receive, from the deep concept classification system, at least one concept matching the at least one input multimedia content element; and
create at least one abnormality identifier for the input multimedia content element, wherein each created abnormality identifier includes at least a portion of the metadata representing the matching at least one concept.

14. The system of claim 11, wherein each reference multimedia content element is associated with at least one predetermined abnormality identifier, wherein the detected at least one abnormality identifier includes the at least one predetermined abnormality identifier of each matching reference multimedia content element.

15. The system of claim 11, wherein the at least one reference multimedia content element includes at least one normal reference multimedia content element featuring at least one baseline identifier, wherein each abnormality identifier is detected with respect to a difference between one of the at least one baseline identifier and the at least one input multimedia content element.

16. The system of claim 11, wherein the system is further configured to:
search, using the detected at least one abnormality identifier, for at least one potential disease.

17. The system of claim 16, wherein the at least one potential disease includes a plurality of potential diseases, wherein the system is further configured to:
send, to a user device, a list of the plurality of potential diseases, wherein the list is organized based on at least one of: a degree of commonness of each potential disease, and a degree of matching between corresponding portions of each input multimedia content element and each reference multimedia content element.

18. The system of claim 11, wherein each input multimedia content element is at least one of: an image, graphics, a video stream, a video clip, an audio stream, an audio clip, a video frame, a photograph, images of signals, and a portion thereof.

19. The system of claim 11, wherein each signature is generated by a signature generator system, wherein the signature generator system includes a plurality of at least partially statistically independent computational cores, wherein the properties of each core are set independently of the properties of each other core.

20. The system of claim 11, further comprising:
a signature generator system, wherein each signature is generated by the signature generator system, wherein the signature generator system includes a plurality of at least partially statistically independent computational cores, wherein the properties of each core are set independently of the properties of each other core.
